(19) United States
(12) Patent Application Publication
(10) Pub. No.: US 2003/0072389 A1
(43) Pub. Date: Apr. 17, 2003

(54) Precision inphase / Quadrature up-down converter structures and methods

(76) Inventors: Frank Xiaohui Li, San Jose, CA (US); Keplin V. Johansen, Santa Clara, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/928,611

(22) Filed: Aug. 13, 2001

(51) Int. Cl. H04L 27/20; H04L 27/22

(52) U.S. Cl. 375/308; 375/329; 329/304; 332/103

(57) ABSTRACT

Precision inphase/quadrature up-down converter structures generally neither requiring trimming at the time of fabrication nor calibration during use. The converters use four mixers arranged to down convert to provide Q, I, \overline{I}and Q baseband signals (or up convert Q, I, \overline{I} and Q baseband signals), the combination of which signals has a very substantially reduced unwanted image frequency content. The use of an increased number of mixers in effect shifts the primary errors from absolute gain and phase errors, to gain and phase error mismatches between elements in replicated circuits, which mismatches can be held to a minimum in circuits replicated in a single integrated circuit.

### BACKGROUND OF THE INVENTION

1. Field of the Invention

The present invention relates to the field of frequency converters, as are commonly used in RF and other communication systems.

2. Prior Art

It is common in RF communications to place data to be transmitted on the inphase (I) and quadrature (Q) components of a baseband signal, to mix these components with the inphase and quadrature components of a local oscillator, and to combine the components so mixed for RF (or other) transmission. Similarly, on reception, the reverse process is carried out to recover the baseband I and Q components for recovery of the data. In the disclosure herein, the present invention will be described with respect to downconverters as used in RF receivers, though the invention is applicable to both downconverters and upconverters, whether for RF communication systems or other communication systems. Accordingly, for direct comparison purposes, the prior art with respect to downconverters will be discussed.

A typical prior art downconverter with ω_{LO}>ω_{RF} for the unwanted image frequencies is illustrated in FIG. 1. Mixers M1 and M2 mix the received RF signal Cos((ω_{RF}t) with mixer pumping signals comprising inphase (0°) and quadrature (−90°) components of the output of quadrature divider driven by a local oscillator signal Cos(ω_{LO}t) to recover the inphase (I) and the quadrature (Q) components of the baseband signal. However, in a typical receiver, there will be amplifiers and filters in each leg, not shown in FIG. 1 for purposes of clarity but causing phase and amplitude errors in a real system, as well as mixer imperfections and imperfections in the orthogonality between the inphase and quadrature components of the output of the quadrature divider. These imperfections cause the appearance of image frequencies in the I and Q baseband signals, diminishing the accuracy of data recovery.

The foregoing imperfections may be categorized as a combination of two effects, namely phase shifts so that the I and Q baseband signals at the output of the downconverter (typically but not necessarily coupled to a digital signal processor (DSP)) are not truly orthogonal, and gain differences so that the I and Q baseband signals at the output of the downconverter do not have the same amplitude. The accumulated phase shifts may be lumped into an equivalent phase shift between the inphase and quadrature components of the signals from the quadrature divider. Taking the inphase component of the quadrature divider signal as a reference, the phase errors may be lumped into the corresponding phase error in the quadrature component of the quadrature divider signal as follows:

phase error=0°/ −(90°+ΔLO)

where:

ΔLO=the cumulative phase error in the Q baseband signal relative to the I baseband signal.

The amplitude errors may be lumped as an amplitude error of the Q baseband signal relative to the I baseband signal, though it may be more instructive in light of a later analysis of the present invention to assign a conversion gain error to each of the I and Q component legs of the downconverter as follows:

Mixer M1 conversion gain error=Δ1

Mixer M2 conversion gain error=Δ2

### PHASE ERROR ANALYSIS—PRIOR ART

Using the phase error assumption, the I and Q components output by mixers M2 and M1 of the converter of FIG. 1, respectively, due to the lumped phase error ΔLO of a single quadrature divider ΔLO, are:

$$M1 ( Q ) \frac{1}{2} Cos [ ( {ω}_{LO} - {ω}_{RF} ) t - ( {90}^{∘} + Δ LO ) ]$$

$$M2 ( I ) \frac{1}{2} Cos [ ( {ω}_{LO} - {ω}_{RF} ) t ]$$

The effect of the phase error may be evaluated by running the output of the mixers through a quadrature combiner, actual in some systems, or simulated for purposes of performance analysis of the converter, as is shown in FIG. 2. The Q component of the converter output would be shifted back 90 degrees by the quadrature combiner, so that the total output of a quadrature combiner for the unwanted image frequencies would be:

$$\frac{1}{2} Cos [ ( {ω}_{LO} - {ω}_{RF} ) t ] + \frac{1}{2} Cos [ ( {ω}_{LO} - {ω}_{RF} ) t - ( {90}^{∘} + Δ LO ) - {90}^{∘} ] = \frac{1}{2} Cos [ ( {ω}_{LO} - {ω}_{RF} ) t ] - \frac{1}{2} Cos [ ( {ω}_{LO} - {ω}_{RF} ) t - Δ LO ]$$

$$Or \text{:}$$

$$\frac{1}{2} \{ Cos [ ( {ω}_{LO} - {ω}_{RF} ) t ] ( 1 - Cos Δ LO ) \} - \frac{1}{2} \{ Sin [ ( {ω}_{LO} - {ω}_{RF} ) t ] Sin Δ LO \}$$

Using the Taylor series expansions, assuming the phase errors are small:

$$Sin ( Δ LO ) = Δ LO - \frac{{( Δ LO )}^{3}}{3 !} + \frac{{( Δ LO )}^{5}}{5 !} … , and$$

$$Cos ( Δ LO ) = 1 - \frac{{( Δ LO )}^{2}}{2 !} + \frac{{( Δ LO )}^{4}}{4 !}$$

The Sin[(ω_{LO}−ω_{RF})t] term in the unwanted image frequencies becomes:

$$1 - Cos Δ LO = - \frac{{( Δ LO )}^{2}}{2 !} + \frac{{( Δ LO )}^{4}}{4 !}$$

If, by way of example, ΔLO is 5 degrees, (ΔLO)²/ 2! is (5π/180)²/2=0.0038.

The Sin[(ω_{LO}−ω_{RF})t] term in the unwanted image frequencies due to a phase error in a conventional I/Q converter, proportional to SinΔLO, is not a small term, but a rather large term directly proportional to the phase error, namely:

$$Sin ( Δ LO ) = Δ LO - \frac{{( Δ LO )}^{3}}{3 !} + \frac{{( Δ LO )}^{5}}{5 !}$$

Thus there is a first order (ΔLO) effect. For a 5 degree phase error, the error is (5π/180)=0.087, or 8.7%.

### AMPLITUDE ERROR ANALYSIS—PRIOR ART

Using the following mixer conversion gain errors and assuming no phase errors:

Mixer 1 conversion gain error=Δ1

Mixer 2 conversion gain error=Δ2

The output (Q) of the first mixer and its difference frequency term is:

(1+Δ1) * Cos(ω_{RF}t) * Cos(ω_{LO}t—90°)

$$Difference frequency term = \frac{1}{2} ( 1 + Δ1 ) Sin ( {ω}_{LO} t - {ω}_{RF} ) t$$

The output (I) of the second mixer and its difference frequency term is:

(1+Δ2) * Cos(ω_{RF}t) * Cos(ω_{LO}t)

$$Difference frequency term = \frac{1}{2} ( 1 + Δ2 ) Cos ( {ω}_{LO} t - {ω}_{RF} ) t$$

The output IRM_OUT of a quadrature combiner on the mixer outputs (FIG. 2) for the image frequencies would be:

$$\frac{1}{2} ( 1 + Δ1 ) Sin ⌊ ( {ω}_{LO} - {ω}_{RF} ) t - {90}^{∘} ⌋ + \frac{1}{2} ( 1 + Δ2 ) Cos ( {ω}_{LO} - {ω}_{RF} ) t = \frac{1}{2} ( Δ2 - Δ1 ) Cos ( {ω}_{LO} - {ω}_{RF} ) t$$

If (Δ2−Δ1)=0, the image rejection will be perfect (IRM_OUT=0 for the image frequencies). This illustrates the point that the important error is the gain mismatch between the two mixers. In most prior art systems, variable gain amplifier/attenuators are used to control the amplitudes of the I and Q signal outputs in unison, leaving the difference in the mixer conversion gains as the important gain error parameter.

Prior art using double quadrature conversion mixers is described in “CMOS Mixers and Polyphase Filters for Large Image Rejection,” authored by Farbod Behbahani et al. Starting on page 880, double quadrature upconversion is described. As shown in FIG. 17 on that page, the inputs to the four mixers are Iᵢₙ, Qᵢₙ, \overline{I}ᵢₙ and \overline{Q}ᵢₙ, with the outputs being I_{RF}, Q_{RF}, \overline{I}_{RF} and \overline{Q}_{RF}. Thus at least one quadrature divider is required on the input side of the four mixers, adding an additional source of gain and phase errors over the present invention. Similarly, starting on page 881, quadrature downconversion is described, with double quadrature downconversion described on page 882. As shown in FIG. 20 on that page, a double quadrature downconverter in accordance with this prior art receives I and Q signal inputs, as well as I and Q mixer pumping inputs, to generate II+QQ and IQ+QI outputs, thus requiring a quadrature divider on the input to the downconverter. Particularly where the input is a high frequency such as an RF frequency, the quadrature divider also causes a high insertion loss, and a high noise figure for the downconverter. In the present invention, such quadrature dividers are not used, and the image rejection is primarily dependent on the matching of errors in circuits, not the errors themselves.

### BRIEF SUMMARY OF THE INVENTION

Precision inphase/quadrature up-down converter structures generally neither requiring trimming at the time of fabrication nor calibration during use. The converters use four mixers arranged to down convert to provide Q, I, \overline{I} and Q baseband signals (or up convert Q, I, \overline{I} and Q baseband signals), the combination of which signals has a very substantially reduced unwanted image frequency content. The use of an increased number of mixers in effect shifts the primary errors from absolute gain and phase errors, to gain and phase error mismatches between elements in replicated circuits, which mismatches can be held to a minimum in circuits replicated in a single integrated circuit.

### BRIEF DESCRIPTION OF THE DRAWINGS

FIG. 1 is a diagram showing a typical prior art downconverter.

FIG. 2 is a diagram of the typical prior art downconverter of FIG. 1 with a quadrature combiner on the converter output.

FIG. 3 is a block diagram of one embodiment of downconverter in accordance with the present invention.

FIG. 4 is a block diagram of the embodiment of downconverter of FIG. 3 with a quadrature combiner on the converter outputs.

### DETAILED DESCRIPTION OF THE PREFERRED EMBODIMENT

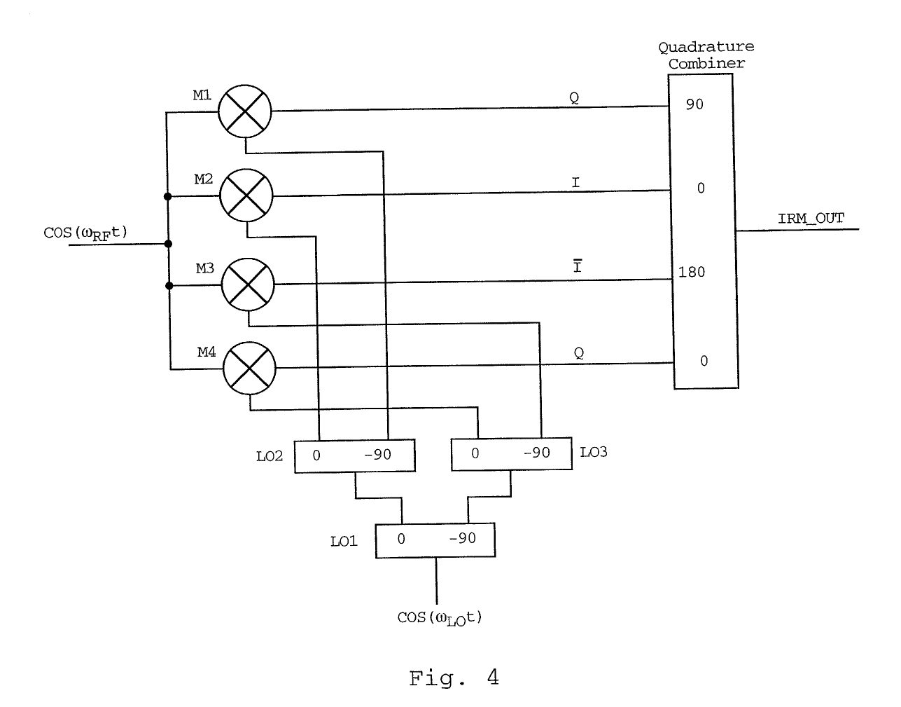

Referring to FIG. 3, a block diagram of one embodiment of the present invention may be seen. As shown therein, an RF signal Cos(ω_{RF}t) is applied to four mixers, M1 through M4. Again assuming, for purposes of illustration only, a downconverter with ω_{LO}>ω_{RF} for the unwanted image frequencies, the second or pumping signal inputs to the mixers are provided by the 0 degree and−90 degree outputs of quadrature dividers LO2 and LO3 controlled by the 0 degree and −90 degree outputs of quadrature divider LO1, itself driven by a local oscillator signal Cos(ω_{LO}t). The four mixer outputs are Q, I, \overline{I} and Q. Neglecting any phase errors, it can be seen that the first Q (quadrature) output is generated by mixer M1 by mixing the RF signal Cos(ω_{RF}t) with Cos(ω_{LO}t) as shifted −90 degrees by quadrature divider LO2, the I (inphase) output is generated by mixer M2 by mixing the RF signal Cos(ω_{RF}t) with Cos(ω_{LO}t), the \overline{I} (the inverse of inphase) output is generated by mixer M3 by mixing the RF signal Cos(ω_{RF}t) with Cos(ω_{LO}t) as shifted −90 degrees by quadrature divider LO1 and another −90 degrees by quadrature divider LO3, and the second Q (quadrature) output is generated by mixer M4 by mixing the RF signal Cos(ω_{RF}t) with Cos(ω_{LO}t) as shifted −90 degrees by quadrature divider LO1. The two Q components, of course, are ideally the same quadrature component of the signal, but determined by the use of different quadrature dividers. Similarly, the I and \overline{I} components are complementary inphase components of the signal, but again, determined by the use of different quadrature dividers.

Another way of looking at the outputs of each of the four mixers is to consider the effect of the respective output of quadrature divider LO1, and then the effect of the output of quadrature divider LO2 or LO3, as the case may be. For instance, the 0 degree output of quadrature divider LO1, would cause an inphase (I) output of a mixer, the −90 degree output of quadrature divider LO1 would cause a quadrature (Q) output of a mixer, the 0 degree output of quadrature divider LO2, would cause an inphase (I) output of a mixer, the −90 degree output of LO2 would cause a quadrature (Q) output of a mixer, etc. Using this analysis, the output of mixer M1 is IQ=Q, the output of mixer M2 is II=I, the output of mixer M3 is QQ=\overline{I}, and the output of mixer M4 is QI=Q.

The following are analyses of the effect of phase errors and amplitude errors in the converter to illustrate the advantages of the present invention. PHASE ERROR ANALYSIS:

Since the inphase (0 degree) outputs of quadrature dividers LO1, LO2 and LO3 are essentially direct pass throughs of the local oscillator signal Cos(ω_{LO}t), assume there will not be any phase error in these components. The quadrature outputs (−90 degree components) however will have some phase error. Thus also assume:

LO1 phase error=0°/ −(90°+ΔLO1)

LO2 phase error=0°/ −(90°+ΔLO2)

LO3 phase error=0°/ −(90°+ΔLO3)

With this assumption, the output (Q) of the first mixer is:

$$Cos ( {ω}_{RF} t ) * Cos ⌊ {ω}_{LO} t - ( {90}^{∘} + Δ LO2 ) ⌋ = \frac{1}{2} \{ Cos [ ( {ω}_{RF} + {ω}_{LO} ) t - ( {90}^{∘} + Δ LO2 ) ] + Cos [ ( {ω}_{RF} - {ω}_{LO} ) t + ( {90}^{∘} + Δ LO2 ) ] \}$$

The output (I) of the second mixer is:

$$Cos ( {ω}_{RF} t ) * Cos ( {ω}_{LO} t ) = \frac{1}{2} \{ Cos [ ( {ω}_{RF} + {ω}_{LO} ) t ] + Cos [ ( {ω}_{RF} - {ω}_{LO} ) t ] \}$$

The output (\overline{I}) of the third mixer is:

$$Cos ( {ω}_{RF} t ) * Cos ⌊ {ω}_{LO} t - ( {90}^{∘} + Δ LO1 ) - ( {90}^{∘} + Δ LO3 ) ⌋ = \frac{1}{2} Cos [ ( {ω}_{RF} + {ω}_{LO} ) t - ( {90}^{∘} + Δ LO1 ) - ( {90}^{∘} + Δ LO3 ) ] + \frac{1}{2} Cos [ ( {ω}_{RF} - {ω}_{LO} ) t + ( {90}^{∘} + Δ LO1 ) + ( {90}^{∘} + Δ LO3 ) ]$$

The output (Q) of the fourth mixer is:

$$Cos ( {ω}_{RF} t ) * Cos ⌊ {ω}_{LO} t - ( {90}^{∘} + Δ LO1 ) ⌋ = \frac{1}{2} \{ Cos [ ( {ω}_{RF} + {ω}_{LO} ) t - ( {90}^{∘} + Δ LO1 ) ] + Cos [ ( {ω}_{RF} - {ω}_{LO} ) t + ( {90}^{∘} + Δ LO1 ) ] \}$$

Only the difference frequency components are of interest in the exemplary embodiment, the sum frequency components being out of the passband of the system and thereby filtered out. The inphase signal output Iₒᵤₜ is taken as the combined inphase signals, namely I−\overline{I}. Thus:

$${I}_{out} = \frac{1}{2} Cos ( {ω}_{RF} - {ω}_{LO} ) t + \frac{1}{2} Cos [ ( {ω}_{RF} - {ω}_{LO} ) t + Δ LO1 + Δ LO3 ]$$

The quadrature signal output Qₒᵤₜ is taken as the combined quadrature signals, namely Q+Q (see FIG. 3). Thus:

$${Q}_{out} = - \frac{1}{2} Sin [ ( {ω}_{RF} - {ω}_{LO} ) t + Δ LO2 ] - \frac{1}{2} Sin [ ( {ω}_{RF} - {ω}_{LO} ) t + Δ LO1 ]$$

The effect of the four mixer configuration of the present invention on the image frequencies may be seen by passing the signals through a quadrature combiner as shown in FIG. 4 to form an image rejection mixer, and then to look at the image remnants remaining. Since ω_{LO}>ω_{RF} for the unwanted image frequencies in the example being described, and recognizing that Cos(−θ)=Cos(θ), the difference frequency outputs for the four mixers can be rewritten as:

$$\begin{matrix}M1 ( Q ) \frac{1}{2} Cos [ ( {ω}_{LO} - {ω}_{RF} ) t - ( {90}^{∘} + Δ LO2 ) ] \\ M2 ( I ) \frac{1}{2} Cos [ ( {ω}_{LO} - {ω}_{RF} ) t ] \\ M3 ( \overline{I} ) \frac{1}{2} Cos [ ( {ω}_{LO} - {ω}_{RF} ) t - ( {90}^{∘} + Δ LO1 ) - ( {90}^{∘} + Δ LO3 ) ] \\ M4 ( Q ) \frac{1}{2} Cos [ ( {ω}_{LO} - {ω}_{RF} ) t - ( {90}^{∘} + Δ LO1 ) ]\end{matrix}$$

The quadrature combiner will shift the Q components back 90 degrees and the \overline{I} component back 180 degrees, and then combine the four signals for the quadrature combiner output IRM_OUT. Thus the output of the quadrature combiner for the image will be:

$$\frac{1}{2} Cos [ ( {ω}_{LO} - {ω}_{RF} ) t - ( {90}^{∘} + Δ LO2 ) - {90}^{∘} ] + \frac{1}{2} Cos [ ( {ω}_{LO} - {ω}_{RF} ) t ] + \frac{1}{2} Cos [ ( {ω}_{LO} - {ω}_{RF} ) t - ( {90}^{∘} + Δ LO1 ) - ( {90}^{∘} + Δ LO3 ) - {180}^{∘} ] + \frac{1}{2} Cos [ ( {ω}_{LO} - {ω}_{RF} ) t - ( {90}^{∘} + Δ LO1 ) - {90}^{∘} ] - \frac{1}{2} Cos [ ( {ω}_{LO} - {ω}_{RF} ) t - Δ LO2 ] + \frac{1}{2} Cos [ ( {ω}_{LO} - {ω}_{RF} ) t ] + \frac{1}{2} Cos [ ( {ω}_{LO} - {ω}_{RF} ) t - Δ LO1 - Δ LO3 ] - \frac{1}{2} Cos [ ( {ω}_{LO} - {ω}_{RF} ) t - Δ LO1 ]$$

Using the identity Cos(x+y)=Cos(x)Cos(y)−Sin(x)Sin(y), where x=(ω_{LO}−ω_{RF})t, this becomes:

$$\frac{1}{2} Cos [ ( {ω}_{LO} - {ω}_{RF} ) t ] [ - Cos Δ LO2 + 1 + Cos ( Δ LO1 + Δ LO3 ) - Cos Δ LO1 ] - \frac{1}{2} Sin [ ( {ω}_{LO} - {ω}_{RF} ) t ] [ + Sin Δ LO2 - Sin ( Δ LO1 + Δ LO3 ) + Sin Δ LO1 ] \\ \text{Or:} \\ \frac{1}{2} Cos [ ( {ω}_{LO} - {ω}_{RF} ) t ] [ 1 - Cos Δ LO2 + Cos ( Δ LO1 + Δ LO3 ) - Cos Δ LO1 ] + \frac{1}{2} Sin [ ( {ω}_{LO} - {ω}_{RF} ) t ] [ Sin ( Δ LO1 + Δ LO3 ) - Sin Δ LO2 - Sin Δ LO1 ]$$

For perfect image rejection:

1−CosΔLO2+Cos(ΔLO1+ΔLO3)−CosΔLO1=0,

and

Sin(ΔLO1+ΔLO3)−SinΔLO2−SinΔLO1=0

If ΔLO2=ΔLO3=0, or if ΔLO1=0, there will be perfect image rejection. Also if ΔLO2=ΔLO3<<ΔLO1, there will be nearly perfect image rejection. Most important, however, is the case where the phase errors for the three quadrature dividers are non-zero, but equal. In an integrated circuit, it is much easier to match circuit phase errors by simply replicating the same circuit, than it is to try to eliminate the phase error in a single circuit, unit to unit, over the temperature operating range, etc. Thus with this assumption:

ΔLO2=ΔLO3=ΔLO1=ΔLO

Now the image rejection will be proportional to:

1−2CosΔLO+Cos(2ΔLO)

and

Sin2ΔLO−2SinΔLO

Using the Taylor series expansions, again assuming the phase errors are small:

$$Sin ( Δ LO ) = Δ LO - \frac{{( Δ LO )}^{3}}{3 !} + \frac{{( Δ LO )}^{5}}{5 !} … , and$$

$$Cos ( Δ LO ) = 1 - \frac{{( Δ LO )}^{2}}{2 !} + \frac{{( Δ LO )}^{4}}{4 !} …$$

the foregoing equations become:

$$1 - 2 Cos Δ LO + Cos ( 2 Δ LO ) = 1 - ( 2 - \frac{2 {( Δ LO )}^{2}}{2 !} + \frac{2 {( Δ LO )}^{4}}{4 !} … ) + ( 1 - \frac{4 {( Δ LO )}^{2}}{2 !} + \frac{16 {( Δ LO )}^{4}}{4 !} … ) = - {( Δ LO )}^{2} + \frac{7 {( Δ LO )}^{4}}{12} … , \\ and$$

$$Sin 2 Δ LO - 2 Sin Δ LO = 2 ( Δ LO ) - \frac{8 {( Δ LO )}^{3}}{3 !} + \frac{32 {( Δ LO )}^{5}}{5 !} … - ( 2 ( Δ LO ) - \frac{2 {( Δ LO )}^{3}}{3 !} + \frac{2 {( Δ LO )}^{5}}{5 !} … ) = - {( Δ LO )}^{3} + \frac{{( Δ LO )}^{5}}{4} …$$

Thus if ΔLO1=ΔLO2=ΔLO3=ΔLO, the undesired image will be present to the extent of:

$$\frac{1}{2} Cos [ ( {ω}_{LO} - {ω}_{RF} ) t ] ( - {( Δ LO )}^{2} + \frac{7 {( Δ LO )}^{4}}{12} … ) , and$$

$$\frac{1}{2} Sin [ ( {ω}_{LO} - {ω}_{RF} ) t ] ( - {( Δ LO )}^{3} + \frac{{( Δ LO )}^{5}}{4} … )$$

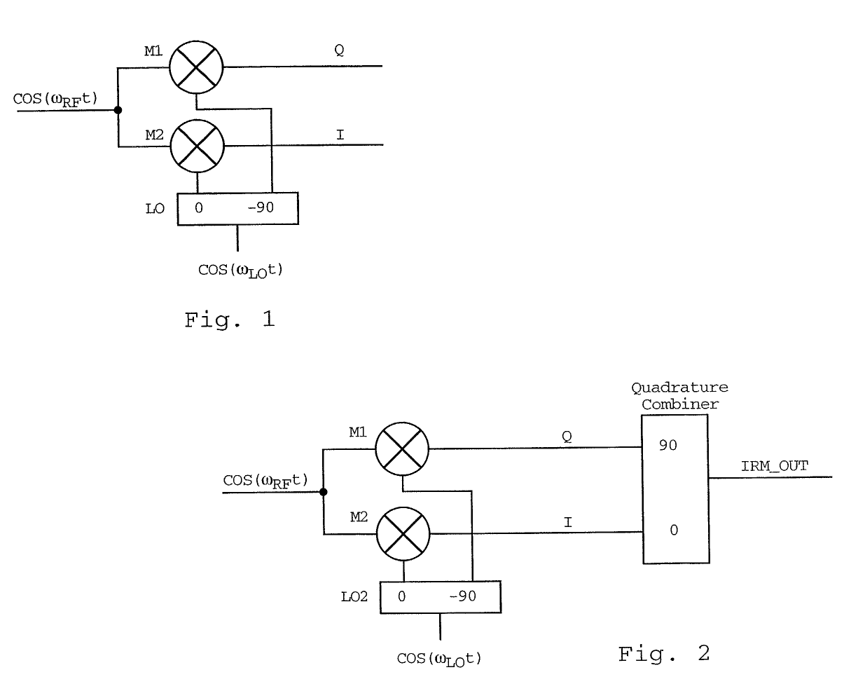

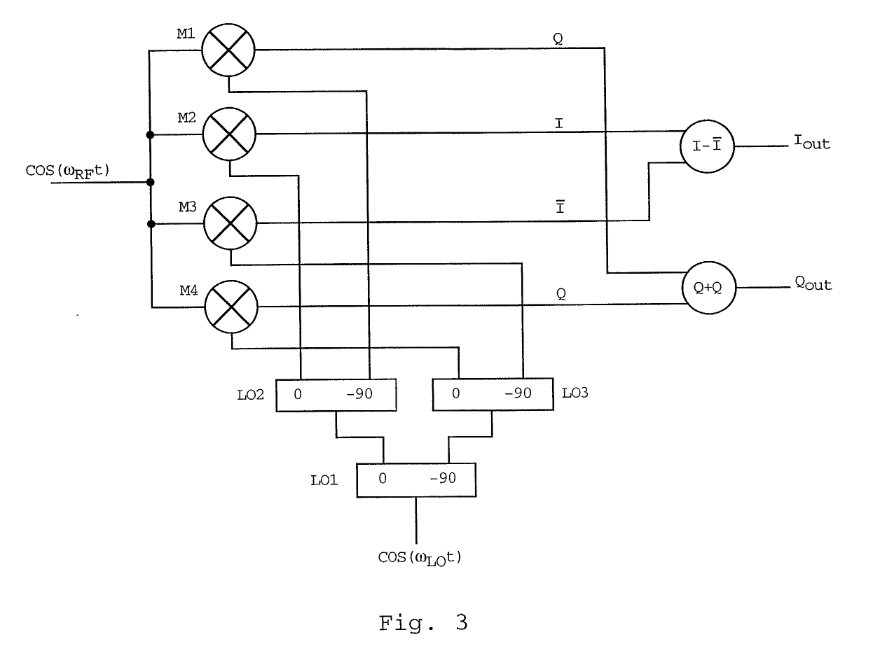

This may be compared to the I and Q components in the prior art (such as the outputs of the mixers M2 and M1 of FIG. 1, respectively), due to a phase error ΔLO of a single quadrature divider. The I and Q components, generalized as to a general phase error ΔLO as described in the prior art section, are:

$$M1 ( Q ) \frac{1}{2} Cos [ ( {ω}_{LO} - {ω}_{RF} ) t - ( {90}^{∘} + Δ LO ) ]$$

$$M2 ( I ) \frac{1}{2} Cos [ ( {ω}_{LO} - {ω}_{RF} ) t ]$$

The Q component would be shifted back 90 degrees by a quadrature combiner, so that the total output of a quadrature combiner would be:

$$\frac{1}{2} Cos [ ( {ω}_{LO} - {ω}_{RF} ) t ] + \frac{1}{2} Cos [ ( {ω}_{LO} - {ω}_{RF} ) t - ( {90}^{∘} + Δ LO ) - {90}^{∘} ] = \frac{1}{2} Cos [ ( {ω}_{LO} - {ω}_{RF} ) t ] - \frac{1}{2} Cos [ ( {ω}_{LO} - {ω}_{RF} ) t - Δ LO ]$$

$$\text{Or:}$$

$$\frac{1}{2} \{ Cos [ ( {ω}_{LO} - {ω}_{RF} ) t ] ( 1 - Cos Δ LO ) \} - \frac{1}{2} \{ Sin [ ( {ω}_{LO} - {ω}_{RF} ) t ] Sin Δ LO \}$$

Thus the magnitude of the 1−CosΔLO term due to a phase error in a conventional I/Q converter is to be compared with the magnitude of the 1−2CosΔLO+Cos(2ΔLO) term due to a uniform phase error in a four mixer I/Q converter in accordance with the present invention, and the magnitude of the SinΔLO term due to a phase error in a conventional I/Q converter is to be compared with the magnitude of the Sin2ΔLO−2SinΔLO term due to a uniform phase error in a four mixer I/Q converter in accordance with the present invention. Using the foregoing Taylor series expansion for the CosΔLO term:

$$1 - Cos Δ LO = - \frac{{( Δ LO )}^{2}}{2 !} + \frac{{( Δ LO )}^{4}}{4 !} …$$

$$1 - 2 Cos Δ LO + Cos ( 2 Δ LO ) = - {( Δ LO )}^{2} + \frac{7 {( Δ LO )}^{4}}{12} …$$

Thus assuming ΔLO is fairly small, the magnitude of the Cos[(ω_{LO}−ω_{RF}) t] term in the unwanted image frequencies has been increased by use of the present invention by a factor of 2. However this term is small anyway if ΔLO is reasonably small. By way of example, if ΔLO is 5 degrees, (ΔLO)² is (5π/180)²=0.0076 compared to 0.0038 for a conventional converter with the same phase error.

The Sin[(ω_{LO}−ω_{RF})t] term in the unwanted image frequencies due to a phase error in a conventional I/Q converter (proportional to SinΔLO) is not a small term, but a rather large term directly proportional to the phase error. Comparing the magnitude of the SinΔLO term due to a phase error in a conventional I/Q converter with the magnitude of the Sin2ΔLO−2SinΔLO term due to a uniform phase error in a four mixer I/Q converter in accordance with the present invention:

$$Sin ( Δ LO ) = Δ LO - \frac{{( Δ LO )}^{3}}{3 !} + \frac{{( Δ LO )}^{5}}{5 !} … , and$$

$$Sin 2 Δ LO - 2 Sin Δ LO = - {( Δ LO )}^{3} + \frac{{( Δ LO )}^{5}}{4} …$$

Thus a first order (ΔLO) effect has been reduced by the present invention to a third order ((ΔLO)³) effect, reducing the effect for a 5 degree phase error from a (5π/180)=0.087 effect to a (5π/180)³=0.00066 effect.

In summary, for the 5 degree phase error illustrative example used herein, the largest term in the unwanted image frequencies due to a phase error in a conventional I/Q converter is 0.087, whereas the largest term in a four mixer I/Q converter in accordance with the present invention is 0.0076, an improvement by more than an order of magnitude.

The improvement in the suppression of image frequencies, or in the rejection of the image itself just illustrated was based on being able to achieve uniform phase errors in the three quadrature dividers (ΔLO1 =ΔLO2=ΔLO3=ΔLO) with some degree of accuracy. This is much more readily achievable than a very low phase error in one quadrature divider, particularly in an integrated circuit, as one only has to replicate the same quadrature divider structure for the three quadrature divider circuits, preferably the three phase shifters being close to each other on the integrated circuit. While the phase errors of the phase shifters will differ, integrated circuit to integrated circuit, and will drift with temperature, and to some extent with time, all three phase shifters on a particular integrated circuit will match and drift together without trimming for alignment, or calibration during use. As long as the phase errors of the three phase shifters are substantially equal, the magnitude of the phase errors doesn't matter much, provided the phase errors remain within reasonable and readily achievable limits.

### Amplitude Error Analysis

FIGS. 3 and 4 are simplified diagrams for a typical converter in accordance with the present invention, in that the output circuits of the mixers will typically include amplifiers and filters, both of which will effect the amplitude of the ultimate I/Q output signals. These errors can be lumped with the conversion gain errors of the mixers and represented by an overall conversion gain error for each I/Q path. Thus normalizing the desired gain to unity, the overall mixer conversion gain errors can be represented as follows:

Mixer M1 conversion gain error=Δ1

Mixer M2 conversion gain error=Δ2

Mixer M3 conversion gain error=Δ3

Mixer M4 conversion gain error=Δ4

Assuming the foregoing conversion gain errors but no phase errors, the output (Q) of the first mixer and its difference frequency term is:

(1+Δ1) * Cos (ω_{RF}t) * Cos(ω_{LO}t−90°)

$$Difference frequency term = \frac{1}{2} ( 1 + Δ1 ) Sin ( {ω}_{LO} t - {ω}_{RF} ) t$$

The output (I) of the second mixer is:

(1+Δ2) * Cos(ω_{RF}t) * Cos(ω_{LO}t)

$$Difference frequency term = \frac{1}{2} ( 1 + Δ2 ) Cos ( {ω}_{LO} t - {ω}_{RF} ) t$$

The output (\overline{I}) of the third mixer is:

(1+Δ3) * COS (ω_{RF}t) * COS(ω_{LO}t −180°)

$$Difference frequency term = - \frac{1}{2} ( 1 + Δ3 ) Cos ( {ω}_{LO} t - {ω}_{RF} ) t$$

The output (Q) of the fourth mixer is:

(1+Δ4) * COS (ω_{RF}t) * COS(ω_{LO}t 90°)

$$Difference frequency term = \frac{1}{2} ( 1 + Δ4 ) Sin ( {ω}_{LO} t - {ω}_{RF} ) t$$

The output IRM_OUT for the image frequencies will be:

$$\frac{1}{2} ( 1 + Δ1 ) Sin ⌊ ( {ω}_{LO} - {ω}_{RF} ) t - {90}^{∘} ⌋ \frac{1}{2} ( 1 + Δ2 ) Cos ( {ω}_{LO} - {ω}_{RF} ) t - \frac{1}{2} ( 1 + Δ3 ) Cos ⌊ ( {ω}_{LO} - {ω}_{RF} ) t - {180}^{∘} ⌋ + \frac{1}{2} ( 1 + Δ4 ) Sin ⌊ ( {ω}_{LO} - {ω}_{RF} ) t - {90}^{∘} ⌋ = \frac{1}{2} ( Δ2 + Δ3 - Δ1 - Δ4 ) Cos ( {ω}_{LO} - {ω}_{RF} ) t$$

If (Δ2+Δ3−Δ1−Δ4)=0, the image rejection will be perfect (IRM_OUT =0 for the image frequencies). Thus:

IRM_OUT=0 when Δ1=Δ2 and Δ3=Δ4,

IRM_OUT=0 when Δ2+Δ3=Δ1+Δ4,

IRM_OUT=0 when Δ1+Δ3 and Δ2=Δ4,

and

IRM_OUT=0 when Δ1−Δ2=Δ3−Δ4

As in the prior art, the important term is the difference in conversion gain errors, though with the present in invention, there should be some reduction in the effect of the conversion gain errors on the unwanted image frequencies because of the averaging effect resulting from the use of 4 mixers in the present invention as opposed to just the 2 mixers of the prior art.

The exemplary embodiments of the invention have been described in detail with respect to downconverters wherein ω_{LO}>ω_{RF} for the unwanted image frequencies (ω_{RF}>ω_{LO} for the wanted frequencies). It will be recognized by those skilled in the art however, that the invention is equally applicable to downconverters wherein ω_{RF}>ω_{LO} for the unwanted image frequencies, and ω_{LO}>ω_{RF} for the wanted frequencies, by simply making certain phase changes (reversals) in the downconverter.

The invention is applicable to downconverters wherein the I and Q outputs are baseband signals. Using a quadrature combiner as in the embodiment of FIG. 4, an image rejection mixer is provided for providing a downshifted (or an up-shifted) intermediate frequency (IF) substantially free of image frequencies. The invention is also directly applicable to upconverters, wherein the I and Q components of a baseband signal is applied to the mixers, the outputs of which are combined to provide an RF (or intermediate frequency) signal, such as for transmission. In general, not only will the quadrature dividers be formed by replicating a single quadrature divider circuit on a single integrated circuit, but also the mixers, and the amplifiers and filters in each mixer leg will be replicated circuits, so that the overall or lumped phase errors will be as equal as possible and track each other over temperature changes, etc., as will amplitude mismatches. Thus while certain preferred embodiments of the present invention have been disclosed in detail herein, such disclosure has been for purposes of illustration and not for purposes of limitation. Thus various changes in form and detail of the present invention will be obvious to those skilled in the art without departing from the spirit and scope of the invention.

What is claimed is:

1. A frequency converter comprising:
first, second, third and fourth mixers, each receiving a signal to be frequency converted;
first, second and third quadrature dividers, each quadrature divider receiving an input signal and providing an inphase and a quadrature component of the respective input signal;
the first quadrature divider receiving an oscillator signal and providing inphase and quadrature components of the oscillator signal as inputs to the second and third quadrature dividers, respectively;
the inphase and quadrature component outputs of the second quadrature divider providing signals to pump the second and first mixers, respectively;
the inphase and quadrature component outputs of the third quadrature divider providing pumping signals to the fourth and third mixers, respectively;
the first and fourth mixers providing quadrature components for combining to provide a quadrature frequency converter output; and,
the second and third mixers inphase and out-of-phase components, respectively, for combining to provide an inphase frequency converter output.

2. The frequency converter of claim 1 wherein the mixers and the quadrature dividers are formed as part of a single integrated circuit.

3. The frequency converter of claim 2 wherein the mixers are fabricated by replication of the same mixer circuit.

4. The frequency converter of claim 2 wherein the quadrature dividers are fabricated by replication of the same quadrature divider circuit.

5. The frequency converter of claim 2 wherein the mixers and quadrature dividers are fabricated by replication of the same mixer and quadrature divider circuits, respectively.

6. The frequency converter of claim 1 further comprised of a quadrature combiner coupled to the output of the mixers.

7. The frequency converter of claim 1 wherein the signal to be converted is an RF signal.

8. The frequency converter of claim 7 wherein the mixer outputs are baseband signals.

9. The frequency converter of claim 1 wherein the oscillator is a local oscillator.

10. A method of frequency conversion comprising:
providing four signals to pump four mixers, the four pumping signals being respective outputs of two quadrature dividers, each having as an input, a respective output of a third quadrature divider receiving an oscillator signal as an input;
providing a frequency to be converted to all four mixers; and,
combining the outputs of two pairs of the four mixers to provide the inphase and the quadrature components of the frequency converted signal.

11. The method of frequency conversion of claim 10 wherein the mixers and the quadrature dividers are formed as part of a single integrated circuit.

12. The method of frequency conversion of claim 11 wherein the mixers are fabricated by replication of the same mixer circuit.

13. The method of frequency conversion of claim 11 wherein the quadrature dividers are fabricated by replication of the same quadrature divider circuit.

14. The method of frequency conversion of claim 11 wherein the mixers and quadrature dividers are fabricated by replication of the same mixer and quadrature divider circuits, respectively.

15. The method of frequency conversion of claim 10 further comprised of a quadrature combiner coupled to the output of the mixers.

16. The method of frequency conversion of claim 10 wherein the signal to be converted is an RF signal.

17. The method of frequency conversion of claim 16 wherein the mixer outputs are baseband signals.

18. The method of frequency conversion of claim 10 further comprising generating the oscillator signal using a local oscillator.
